(19) United States
(12) Patent Application Publication
(10) Pub. No.: US 2019/0369277 A1
(43) Pub. Date: Dec. 5, 2019

(54) System for Generating a Model of an Underground Formation from Seismic Data

(71) Applicant: Advanced Geophysical Technology, Inc., Sugar Land, TX (US)

(72) Inventor: Wenyi Hu, Fulshear, TX (US)

(21) Appl. No.: 15/836,104

(22) Filed: Dec. 8, 2017

(51) Int. Cl. G01V 1/28; G01V 1/30; G06F 17/13; G06F 17/16

(52) U.S. Cl. CPC G01V 1/282; G01V 1/307; G06F 17/16; G06F 17/13; G01V 1/303

(57) ABSTRACT

A full wave inversion (FWI) may utilize an Amplitude-Frequency-Differentiation (AFD) or a Phase-Frequency-Differentiation (PFD) operation to form a velocity model of a subterranean formation utilizing recovered low wavenumber data. Received seismic data is processes to isolate two data signals at different frequencies. In an AFD operation, the two data signals are summed and the data of the envelope of the summed function is used for the FWI. In a PFD operation, the phase data of the quotient of the two data signals is used for the FWI. The FWI proceeds iteratively utilizing either the AFD or PFD data or with single frequency data until the cost function of the AFD or PFD is satisfied.

### CROSS-REFERENCE TO RELATED APPLICATIONS

This application is a non-provisional application which claims priority from U.S. non-provisional application Ser. No. 15/004,689, filed Jan. 22, 2016, which in turn claims priority from U.S. provisional application No. 62/107,025, filed Jan. 23, 2015, the entirety of both hereby incorporated by reference.

### TECHNICAL FIELD/FIELD OF THE DISCLOSURE

The present disclosure relates to processing of seismic data.

### BACKGROUND OF THE DISCLOSURE

In order to determine the composition and structure of an underground formation, seismic data may be utilized. As understood in the art, when a seismic wave propagates through the earth from a source to a receiver, the received seismic wave may bring information about geophysical properties of the subsurface volume. The properties may include, without limitation, seismic wave velocity, mass density, and anisotropy properties. In exploration geophysics, by recording the seismic waves at the surface by one or more geophones or hydrophones, a model of the subsurface strata may be determined through various seismic processing techniques.

The time between transmission of the seismic wave and reception of the reflected seismic waves may be measured to determine the distance to an interface. More advanced techniques, such as reflection velocity tomography, are capable of using kinematic information contained in the seismic reflection data to transform the seismic data gathered from the reflected waves to determine a more detailed and complete model of the underground seismic velocity model. Another technique, known as full waveform inversion (FWI), utilizes full waveform information, i.e. both phase and amplitude data, both transmission seismic data and reflection seismic data, both primaries and multiples, contained in the seismic data gathered from the recorded seismic waves to generate a high resolution velocity model or other geophysical property model of the underground formation through optimal data fitting.

Because of hardware limitations of geophones and hydrophones, seismic data is typically band limited, rendering low frequency seismic data unavailable. Due to the lack of low frequency data, large underground structures are less able to be identified due to issues including without limitation nonlinearity of the FWI and the cycle-skipping phenomenon. Nonlinearity and cycle-skipping can result in incorrect data fitting as, for example, the inversion may be trapped in local minima, preventing the updated models from progressing properly. Nonlinearity and cycle-skipping each increase in effect and likelihood with increasing frequency during an inversion operation.

### SUMMARY

The present disclosure provides for a method for generating a model of an underground formation from seismic data. The method may include measuring seismic data from one or more receivers in the time domain. The one or more receivers may be positioned to receive seismic waves generated by a source and emitted into the underground formation, the seismic waves forming the seismic data. The method may further include converting the seismic data from the time domain to the frequency domain to form frequency domain seismic data. The method may further include extracting, from the frequency domain seismic data, first measured frequency domain data from corresponding to a first signal at a first frequency. The method may further include extracting, from the frequency domain seismic data, second measured frequency domain data corresponding to a second signal at a second frequency. The second frequency is different from the first frequency. The method may further include generating, from a first velocity model, first simulated frequency domain data at the first frequency and second simulated frequency domain data at the second frequency. The method may further include calculating a gradient of a cost function utilizing the first and second measured frequency domain data and first and second simulated frequency domain data. The method may further include generating a second velocity model based at least in part on the calculated gradient, the second velocity model corresponding to at least one feature of the underground formation.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A illustrates two signals, S₁(t) and S₂(t).

FIG. 1B illustrates beat signal, S_{B}(t), a result of S₁(t) superimposed with S₂(t).

FIG. 2A depicts real parts of frequency domain data S₁ and S₂ overlaid as received by the receivers.

FIG. 2B depicts S_{B}, calculated by computing the absolute value of the amplitude or the envelope of the summation of frequency domain data from signals S₁ at f₁ and S₂ at f₂.

FIG. 3A depicts velocity anomalies as ideally detectable by the receivers.

FIG. 3B depicts real parts of frequency domain data from signals S₁ and S₂ as computed.

FIG. 3C depicts beat signal S_{B} (the envelope of S₁+S₂) and real part of true low frequency data S_{LF}, showing the effect of the anomalies on S_{B}.

FIG. 4A depicts the phases of frequency domain data from signals S₁ at frequency f₁ and S₂ at frequency f₂ overlaid as received by the receivers.

FIG. 4B depicts the phase of S_{B} (i.e., Φ(S₁/S₂)).

FIG. 5A depicts velocity anomalies as ideally detectable by the receivers.

FIG. 5B depicts the phases of S₁ and S₂ as received.

FIG. 5C depicts S_{B} (i.e., Φ(S₁/S₂)) and the phase of S_{LF}, showing the effect of the anomalies on the phase of S_{B}.

FIG. 6A depicts a test model (here, the Marmousi model) with a single source and the associated multiple receivers depicted at the top thereof.

FIG. 6B depicts the phase data of S₁ and S₂ as receive by the receivers.

FIG. 6C depicts a beat signal data (i.e., Φ(S₁/S₂)) as a result of the PFD technique.

FIG. 7A depicts a true seismic velocity model for the exemplary PFD FWI operation, here depicted as the Marmousi model.

FIG. 7B depicts an initial model used.

FIG. 7C illustrates a model that resulted from extracted Data from a shot wherein S₁ is at 5 Hz and S₂ is at 5.5 Hz and is used with the PFD inversion

FIG. 7D illustrates a final model result.

FIG. 8 is a flow chart depicting an FWI consistent with embodiments of the present disclosure.

FIG. 9 illustrates a schematic diagram of a computer according to an embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In the following disclosure, it is to be understood that frequency of a signal may be expressed as either ordinary frequency, commonly measured in cycles per second or Hz, or angular frequency, measured in radians per second. As used herein, f refers to ordinary frequency and ω refers to angular frequency. One having ordinary skill in the art with the benefit of this disclosure will understand that the frequencies are related according to:

ω=2πf

and thus unless explicitly stated otherwise, the use of one or the other is not intended to be limiting.

In some embodiments of the present disclosure, a seismic geologic survey is carried out utilizing a seismic source commonly referred to as a “shot” to generate seismic waves. As understood in the art, the shot may be band limited, but include seismic waves in a range of frequencies. In some embodiments, the shot may create seismic waves from, for example and without limitation, 0.2 to 100 Hz. In analyzing the seismic waves received by the one or more geophones or hydrophones, frequency domain data may be extracted from the received time domain seismic waves corresponding to two frequencies of seismic waves using various signal processing techniques. These signals are referred to herein as S₁ and S₂. The frequencies of S₁ and S₂ are selected to be different but close to each other. In some embodiments, S₁ and S₂ may each be between 4 and 100 Hz, between 5 and 30 Hz, or between 5 and 15 Hz. In some embodiments, for example and without limitation, S₁ and S₂ may be separated by 5 Hz or less, 2 Hz or less, or 0.5 Hz or less.

As understood in the art, when two time domain single frequency acoustic waves are close in frequency, the interference between the two signals may result in an apparently single tone of temporally varying volume or amplitude. The rate of variation in volume, known as a beat frequency, is determined by the difference between the two sound frequencies. For a first signal, S₁(t)=cos(2πf₁t) and a second signal S₂(t)=cos(2πf₂t), where |f₁−f₂|<<f₁ and f₂, the summation of the two signals is given by:

$${S}_{3} ( t ) = {S}_{1} ( t ) + {S}_{2} ( t ) = 2 cos ( 2 π \frac{{f}_{1} + {f}_{2}}{2} t ) cos ( 2 π \frac{{f}_{2} - {f}_{1}}{2} t )$$

The addition of S₁(t) and S₂(t) creates a perceived carrier signal

$$( defined by {S}_{c} ( t ) = 2 cos ( 2 π \frac{{f}_{1} + {f}_{2}}{2} t ) ) ,$$

whose amplitude varies slowly with the beat frequency

$${f}_{b} = \frac{{f}_{2} - {f}_{1}}{2}$$

(according to the

$$cos ( 2 π \frac{{f}_{2} - {f}_{1}}{2} t )$$

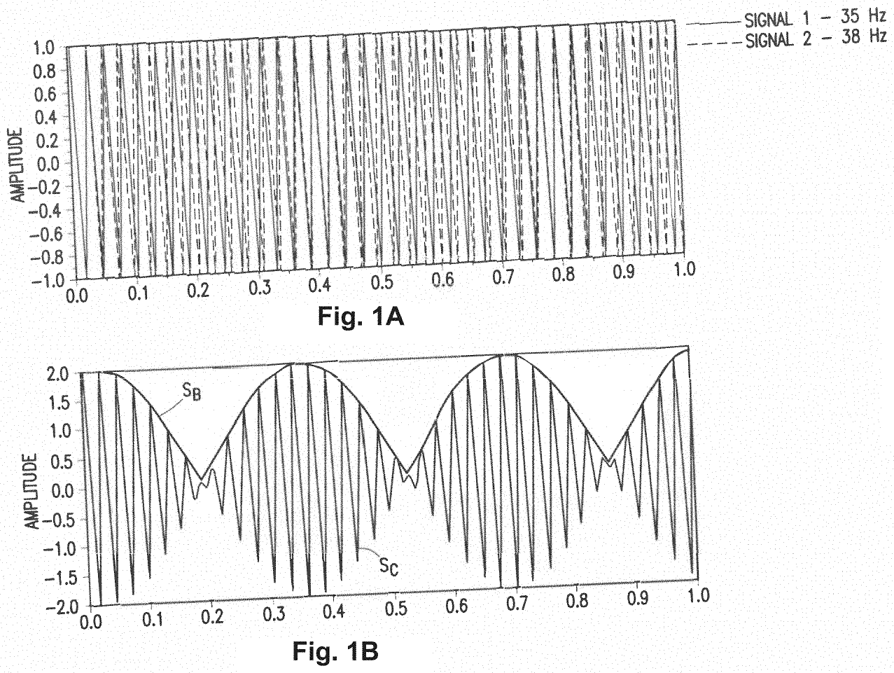

term). Thus, by selecting the difference in frequency between S₁(t) and S₂(t), the high frequency carrier signal S_{c}(t), is modulated with the low frequency beat signal. In some embodiments, as an example and without limitation, for time domain single frequency signals, by taking the envelope of S₃(t), referred to herein as beat signal S_{B}(t), low frequency data may be extracted from the high-frequency signals S₁(t) and S₂(t). As depicted in FIG. 1A, signals S₁(t) and S₂(t) when superimposed create the amplitude variations of beat signal S_{B}(t) as shown in FIG. 1B, and the frequency of beat signal S_{B}(t) is determined by the difference in frequency between signals S₁(t), S₂(t). By selecting the frequencies of S₁(t) and S₂(t) close to one another, beat signal S_{B}(t) may have a low frequency.

As understood in the art, when two frequency domain seismic waves recorded at multiple spatial locations are close in frequency, the interference between the two signals results in an apparently single tone of spatially varying amplitude. The rate of variation in amplitude is determined by the difference between the two seismic wave frequencies or wavenumbers. As understood in the art, wavenumber refers to the spatial frequency of a wave, and may be calculated according to:

$$k = \frac{ω}{v}$$

where k is the wavenumber and v is the phase velocity of the wave. For a first signal, S₁(x)=exp(ik₁x) and a second signal S₂(x)=exp(ik₂x), where x is the spatial location

$$\vert {f}_{1} - {f}_{2} \vert ≪ {f}_{1} and {f}_{2} , {k}_{1} = \frac{{ω}_{1}}{v} , {k}_{2} = \frac{{ω}_{2}}{v} ,$$

the summation of the two signals is given by:

$${S}_{3} ( x ) = {S}_{1} ( x ) + {S}_{2} ( x ) = \frac{2}{\vert x \vert} exp ( \frac{{k}_{1} + {k}_{2}}{2} x ) cos ( \frac{{k}_{2} - {k}_{1}}{2} x )$$

The addition of S₁(x) and S₂(x) creates a perceived carrier signal

$$( defined by {S}_{c} ( x ) = exp ( \frac{{k}_{1} + {k}_{2}}{2} x ) ) ,$$

whose amplitude varies slowly with the beat wavenumber

$${k}_{b} = \frac{{k}_{2} - {k}_{1}}{2}$$

(according to the

$$cos ( \frac{{k}_{2} - {k}_{1}}{2} x )$$

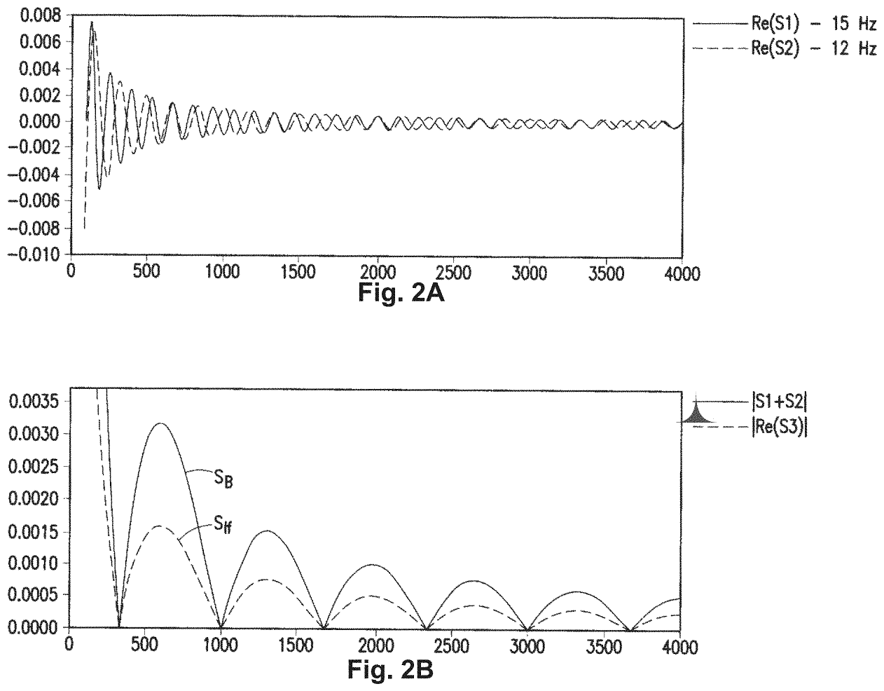

term). Thus, by selecting the difference in frequency between S₁(x) and S₂(x), the high wavenumber carrier signal S_{c}(x) is modulated with the low wavenumber beat signal. In some embodiments, as an example and without limitation, for frequency domain signals, by taking the envelope of S₃(x), referred to herein as beat signal S_{B}(x), low wavenumber data may be extracted from the high-wavenumber signals S₁(x) and S₂(x). As depicted in FIG. 2A, signals S₁(x) and S₂(x) when superimposed create the amplitude variations of beat signal S_{B}(x) as shown in FIG. 2B, and the wavenumber of beat signal S_{B}(t) is determined by the difference in wavenumber or frequency between signals S₁(x), S₂(x). By selecting the frequencies of S₁(x) and S₂(x) close to one another, beat signal S_{B}(x) may have a low wavenumber.

By utilizing the data in a low wavenumber beat signal S_{B} for a FWI operation, otherwise unavailable low wavenumber data may be obtained.

An FWI inversion begins with an initial model, referred to herein as κ₀. After iterative inversions of seismic data, the model is gradually updated by using determined gradient information. Acoustic waves propagate according to:

∇²p+ω²ρκp=−iωQ

where p is the pressure, Q is the injected volume acting as the source, ρ is the mass density, and κ is the compressibility of the medium. The seismic P-wave velocity, vₚ is determined according to:

vₚ=1/\sqrt{ρκ}

The model is updated until a model κₙ=κ₀+Δκ which is close to the true model (referred to herein as κₜᵣᵤₑ) is determined, such that the simulated data closely fits the measured data. The gradient information is calculated from the sensitivity kernel, i.e. the response of the simulated data to the perturbation of the medium property, according to:

$$\frac{\partial p}{\partial κ} = - {ρω}^{2} {\int }_{τ} p ( ω , κ ; x , {x}_{r} ) G ( ω , κ ; x , {x}_{s} ) dx$$

where G(ω,κ;x,xₛ) is the Green's function, i.e., the solution to

∇²p+ω²ρκp=δ(x−xₛ)

Because is a

$$\frac{\partial p}{\partial κ}$$

is a function of κ and ω, the inversion is nonlinear, and the level of nonlinearity increases with increasing frequency. Additionally, if the simulated data at κₙ=κ₀ and the measurement data are out of phase for more than a half period, then the gradient-based search direction will be incorrect, a phenomenon known as cycle-skipping, causing errors to propagate in subsequent models.

In some embodiments of the present disclosure, the low wavenumber information buried in beat signal S_{B} may be extracted to carry out the FWI operation and reconstruct a model for the underground formation without suffering from cycle-skipping. Rather than inverting data from signal S₁ at frequency f₁, or data from signal S₂ at frequency f₂, or data from signal S₃ at frequencies f₁ and f₂ using the conventional FWI method, for example and without limitation, the inversion may be carried out utilizing the low wavenumber data extracted from beat signal S_{B}, which is constructed from high frequency seismic data at two different frequencies through mathematical operations and signal processing techniques.

In some embodiments, FWI may be carried out utilizing the amplitude data of beat signal S_{B}. In such an amplitude-frequency differentiation (AFD) inversion, beat signal S_{B} may be defined as the envelope of S₃, which may then be utilized as the input data of at least one iteration of the FWI operation. As an example, FIGS. 2A and 2B depict simulated data received by 313 receivers located evenly from 100 m to 4000 m from a signal source at 0 m with constant seismic velocity v. FIG. 2A depicts real parts of frequency domain data S₁ and S₂ overlaid as received by the receivers. FIG. 2B depicts S_{B}, calculated by computing the absolute value of the amplitude or the envelope of the summation of frequency domain data from signals S₁ at f₁ and S₂ at f₂. FIG. 2B also depicts S_{LF}. S_{LF}, shown only for comparison purposes, corresponds to a true low frequency signal captured at the frequency

$$\frac{{f}_{1} - {f}_{2}}{2} .$$

In this nonlimiting example, S₁ and S₂ are 15 and 12 Hz respectively, with S_{LF} thus being 1.5 Hz. As can be seen, although S_{B} is constructed from high frequency seismic data, it includes all the same low wavenumber information as the true low frequency S_{LF}, also shown by:

$${S}_{1} + {S}_{2} = \frac{2}{\vert x \vert} cos ( \frac{{k}_{1} - {k}_{2}}{2} x ) exp ( - i \frac{{k}_{1} + {k}_{2}}{2} x )$$

and thus:

$$\vert {S}_{1} + {S}_{2} \vert = 2 \vert cos ( \frac{{k}_{1} - {k}_{2}}{2} x ) / x \vert$$

By inverting |S₁+S₂| instead of S₁ or S₂ alone, for example and without limitation, during FWI processes, low wavenumber information contained in beat signal may contribute to the recovery of large scale structures while mitigating issues with cycle-skipping and local minima without using true low frequency seismic data. Because S_{B} includes all the same low wavenumber information as the true low frequency S_{LF}, the FWI result obtained by inverting data from beat signal S_{B} is expected to be identical or close to that obtained by inverting data S_{LF}.

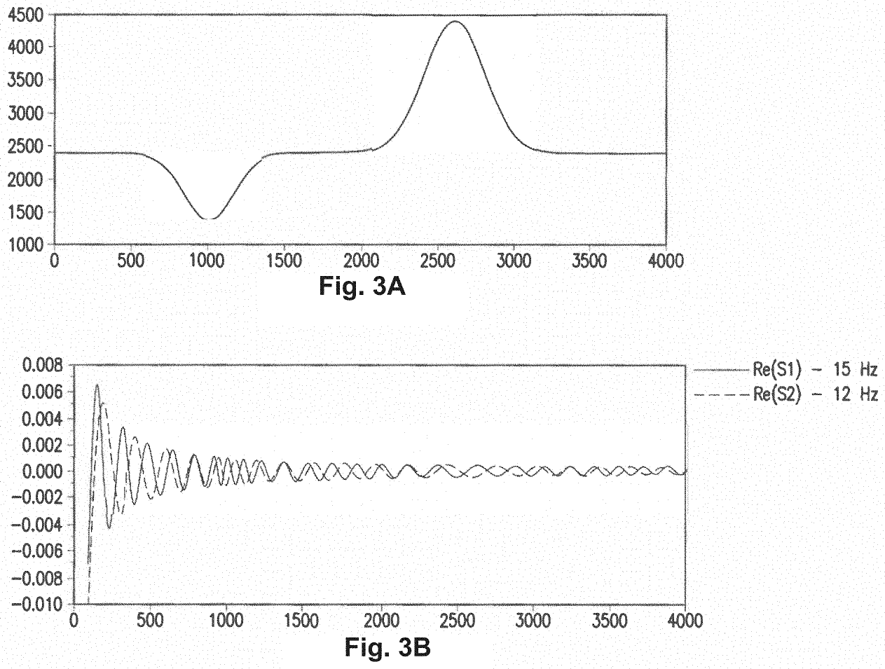

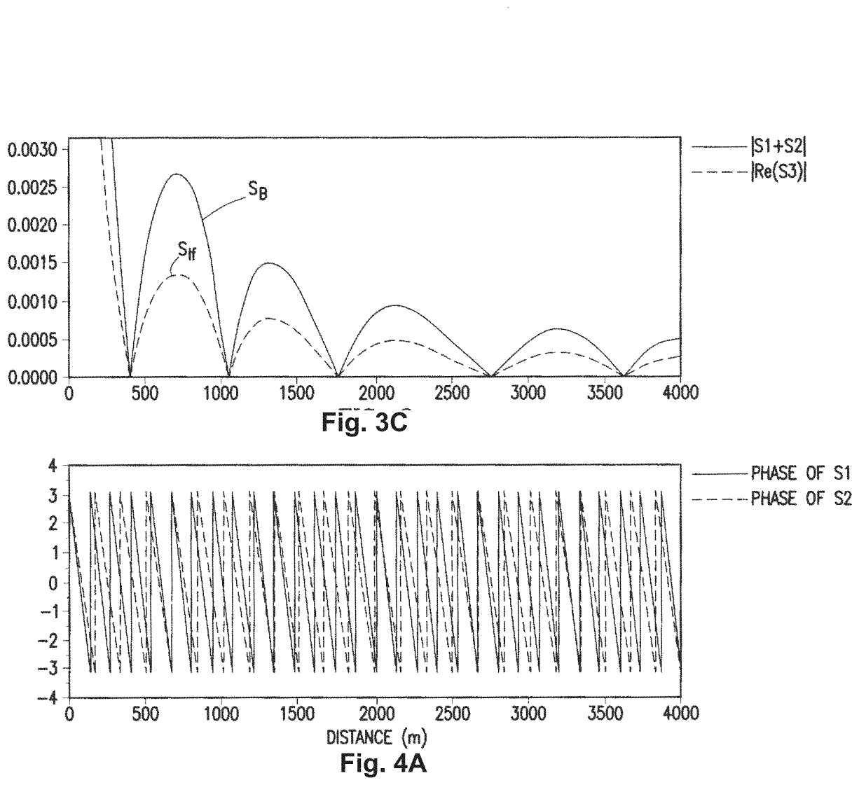

As an example, FIG. 3A depicts velocity anomalies as ideally detectable by the receivers. FIG. 3B depicts real parts of frequency domain data from signals S₁ and S₂ as computed. FIG. 3C depicts beat signal S_{B} (the envelope of S₁+S₂) and real part of true low frequency data S_{LF}, showing the effect of the anomalies on S_{B}.

In order to carry out FWI utilizing the AFD data, beat signal S_{B} may be used to determine an initial model after which single-frequency FWI (for example using only S₁, S₂, or another seismic signal at another frequency) may be utilized to generate subsequent, updated models. In other embodiments, beat signal S_{B} may be used to determine the initial model KO as well as each subsequent model κₙ. In some embodiments, for each iteration of the FWI, beat signal S_{B} may be generated by S₁ and S₂ at constant frequencies. In other embodiments, for each iteration of the FWI, beat signal S_{B} may be generated by S₁ and S₂ at different frequencies selected to generate a different beat signal S_{B}. In some embodiments, for each iteration, beat signal S_{B} may be generated by a variation in one or both of S₁ and S₂.

At each iteration, the quality of the fit may be calculated according to the cost function for AFD, given by:

C(mₙ)=½∥|S(ω₁)+S(ω₂)|²−|M(ω₁)+M(ω₂)|²∥²+λₙRₙ(mₙ)

where S is the simulated data from the model, M is the measurement data, m is the unknown vector, a function of seismic velocity model v or compressibility model κ, to be inverted, λ, is the regularization parameter, R is the regularization term, ω is the angular frequency, and n denotes the iteration index. By minimizing C(mₙ) or iterating until it is within an acceptable error tolerance, the fit of the generated model may be improved. As understood by one having ordinary skill in the art with the benefit of this disclosure, as the simulated data becomes closer to the measurement data, the value of the cost function decreases.

In some embodiments, FWI may be carried out utilizing phase data of S₁/S₂ to render low wavenumber information to inversion processes. In such a phase-frequency differentiation (PFD) inversion, beat signal data is defined as Φ(S₁/S₂), i.e., phase of S₁/S₂, rather than envelope of S₁+S₂ as in AFD. In some embodiments, dividing S₁ by S₂ may, for example and without limitation, reduce the effects of source estimation uncertainty, measurement error, or unnecessary cross talk between reflection energy.

Utilizing the phase-frequency-differentiation data (i.e., beat signal data in PFD method) may mitigate or eliminate errors caused by, for example and without limitation, sensitivity to amplitude measurement error, unknown attenuation parameters Q, and uncertainty of mass density.

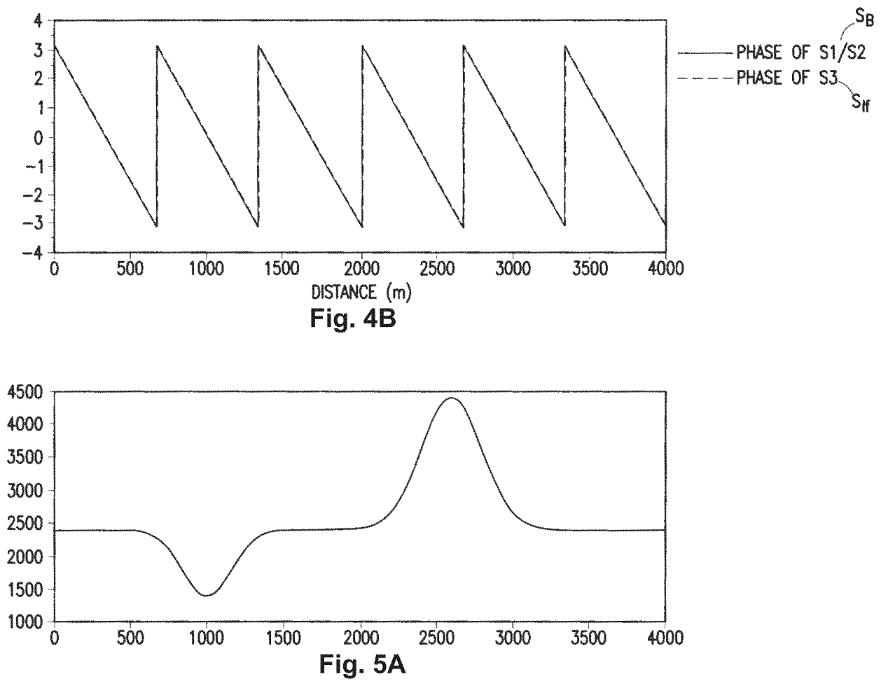

As an example, FIGS. 4A and 4B depict simulated data received by 313 receivers located evenly from 100 m to 4000 m from a signal source at 0 m with constant seismic velocity v. FIG. 4A depicts the phases of frequency domain data from signals S₁ at frequency f₁ and S₂ at frequency f₂ overlaid as received by the receivers. FIG. 4B depicts the phase of S_{B} (i.e., Φ(S₁/S₂)). FIG. 4B also depicts the phase of S_{LF}. The phase of S_{LF}, shown only for comparison purposes, corresponds to a true low frequency signal captured at the frequency of f₁-f₂. As can be seen, the phase of S1/S₂ and S_{LF} are identical.

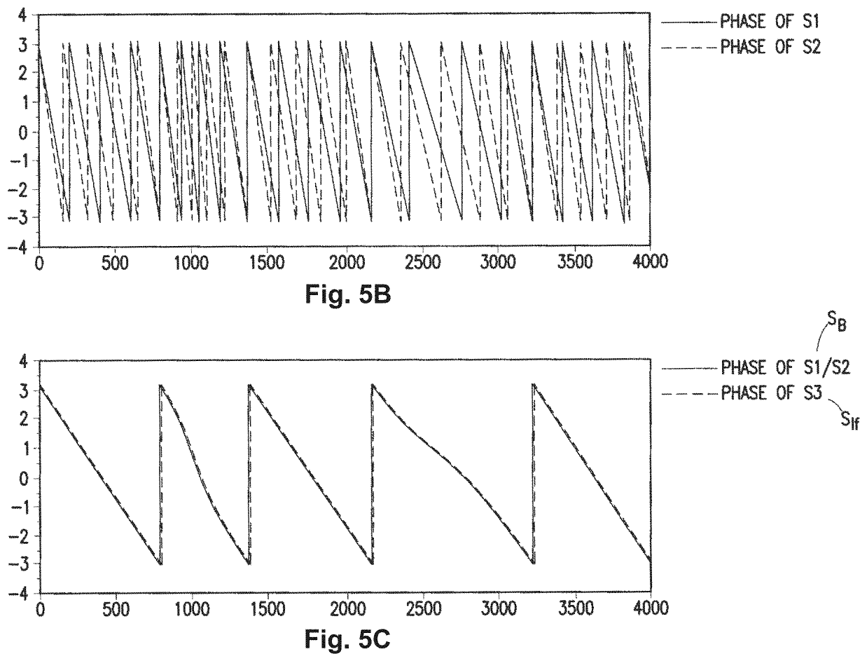

As an example, FIG. 5A depicts velocity anomalies as ideally detectable by the receivers. FIG. 5B depicts the phases of S₁ and S₂ as received. FIG. 5C depicts S_{B} (i.e., Φ(S₁/S₂)) and the phase of S_{LF}, showing the effect of the anomalies on the phase of S_{B}. Because S_{B} and the phase of data S_{LF} are identical, the FWI result obtained by inverting data S_{B} is expected to be identical or close to that obtained by inverting the data S_{LF}.

In order to carry out FWI utilizing the PFD data, the beat signal S_{B} may be used to determine an initial model after which single-frequency FWI (for example using only S₁, S₂, or another seismic signal at another frequency) may be utilized to generate subsequent, updated models. In other embodiments, beat signal S_{B} may be used to determine the initial model KO as well as each subsequent model κₙ. In some embodiments, for each iteration of the FWI, beat signal S_{B} may be generated by S₁ and S₂ at constant frequencies. In other embodiments, for each iteration of the FWI, beat signal S_{B} may be generated by S₁ and S₂ at different frequencies selected to generate a different beat signal S_{B}. In some embodiments, for each iteration, beat signal S_{B} may be generated by a variation in one or both of S₁ and S₂.

At each iteration, the quality of the fit may be calculated according to the cost function for PFD, given by:

C(mₙ)=½∥Φ[S(ω₂)/S(ω₁)]−Φ[M(ω₂)/M(ω₁)]∥²+λₙRₙ(mₙ)

where S is the simulated data from the model, M is the measurement data, m is the unknown vector to be inverted, λ is the regularization parameter, R is the regularization term, ω is the angular frequency, Φ is the phase extraction operator, and n denotes the iteration index. By minimizing C(mₙ) or iterating until it is within an acceptable error tolerance, the fit of the generated model may be improved. The gradient vector of the cost function with respect to the unknown vector m, a function of seismic velocity model v or compressibility model κ, is calculated. The gradient vector alone, or combined with other information, may be utilized in the FWI inversion processes for velocity model update direction searching to minimize the cost function.

As understood by one having ordinary skill in the art with the benefit of this disclosure, as the simulated data becomes closer to the measurement data, the value of the cost function decreases.

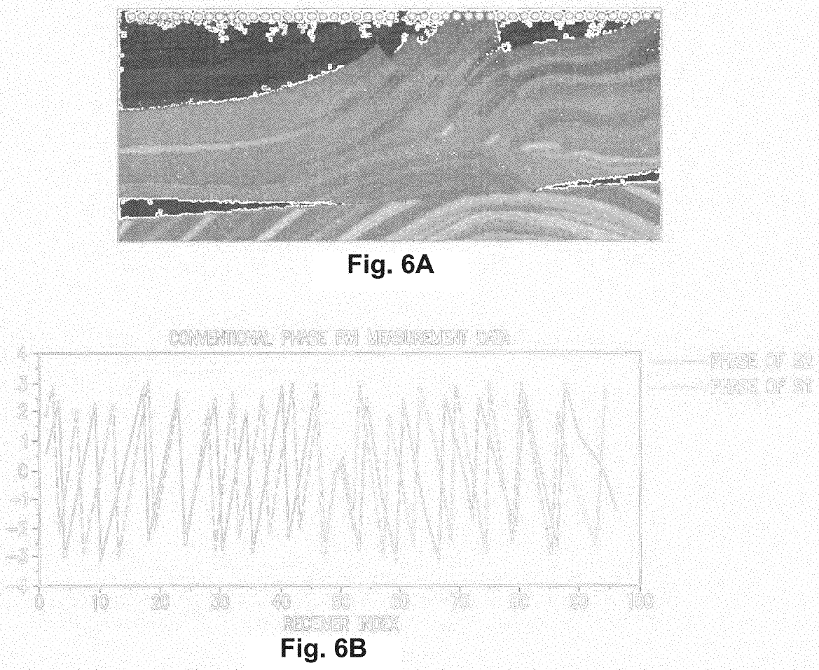

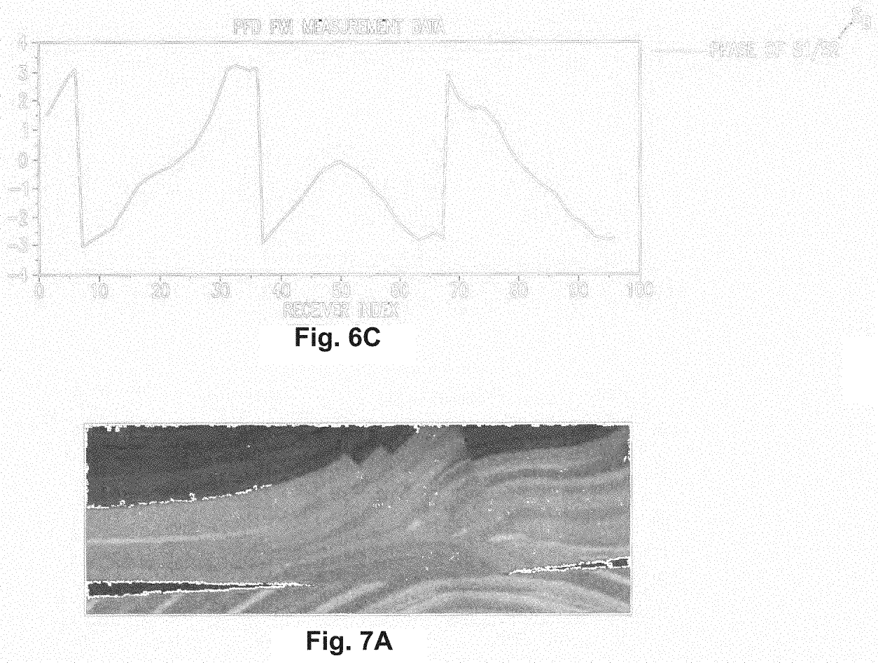

As another example of PFD measurement data (i.e., beat signal data) to be inverted, FIG. 6A depicts a test model (here, the Marmousi model) with a single source and the associated multiple receivers depicted at the top thereof. FIG. 6B depicts the phase data of S₁ and S₂ as receive by the receivers. FIG. 6C depicts the beat signal data (i.e., Φ(S₁/S₂)) as a result of the PFD technique described hereinabove. As is clearly visible, the beat signal data (i.e., Φ(S₁/S₂)) includes far fewer phase-wraps, thus reducing the possibility of cycle-skipping.

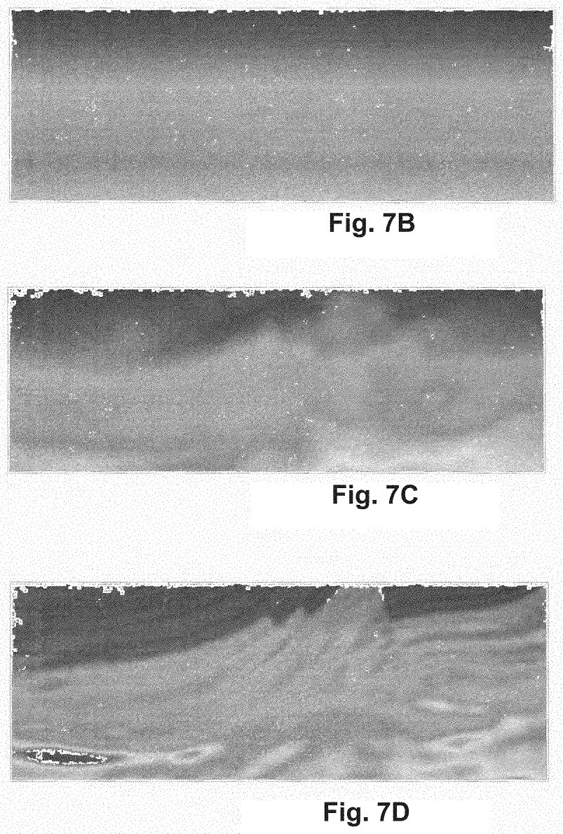

In order to further the understanding of the present disclosure, a merely exemplary and non-limiting PFD FWI operation is depicted in FIGS. 7A-7D. FIG. 7A depicts the true seismic velocity model for the exemplary PFD FWI operation, here depicted as the Marmousi model. FIG. 7B depicts the initial model used. Data is extracted from a shot such that S₁ is at 5 Hz and S₂ is at 5.5 Hz and is used with the PFD inversion as discussed above, resulting in the model shown in FIG. 7C. This model is used as the starting model for a FWI operation, which after several operations utilizing single frequency data results in the final model result depicted in FIG. 7D.

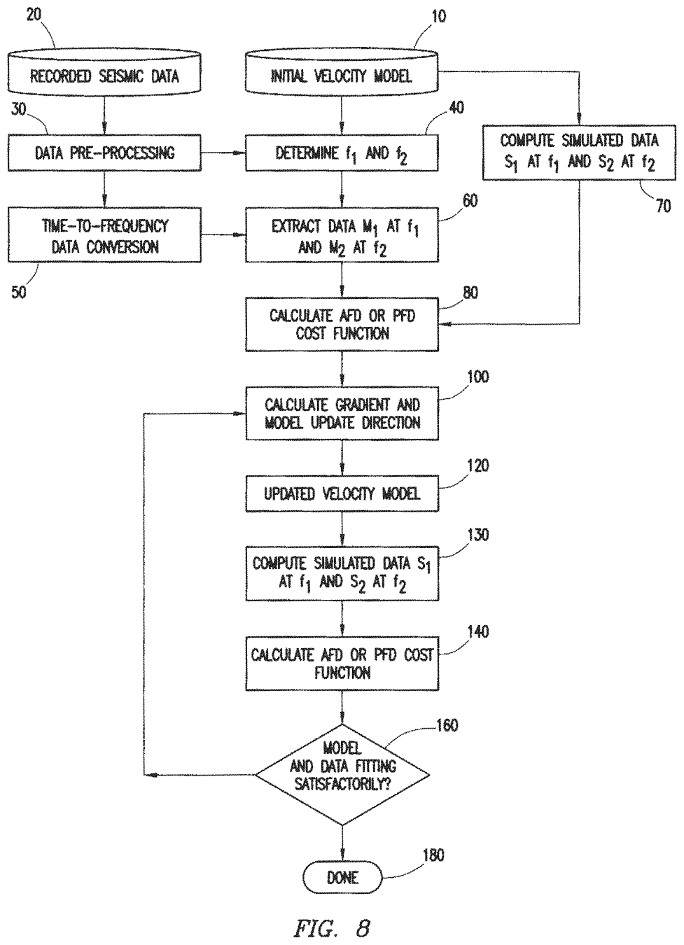

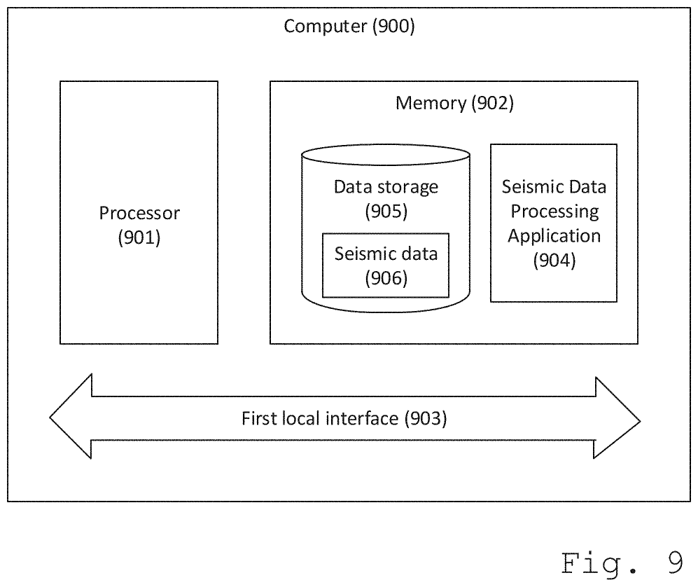

In order to further the understanding of this disclosure, FIG. 8 depicts a flow chart of a FWI operation consistent with embodiments of the present disclosure. FIG. 8 is intended as an example and is not intended as limiting the scope of the disclosure in any way. As previously discussed, seismic data is recorded (20). In some embodiments, the seismic data may be pre-processed (30). Pre-processing may include, for example and without limitation, filtering of the recorded data.

The two frequencies f₁ and f₂ for beat signal construction may be determined (40) based on, for example and without limitation, knowledge of initial velocity model (10) and the quality and frequency range of the pre-processed data. The pre-processed time domain seismic data may be converted to frequency domain data (50) using signal processing techniques. The frequency domain data at frequency f₁ and f₂ may be extracted as M₁ and M₂ (60). The initial velocity model may be input to a seismic wave propagation engine to generate the simulated frequency domain data from signals S₁ with the frequency f₁ and S₂ with the frequency f₂ (70). The cost function and the data residual of AFD method or PFD method may then be calculated using the measurement data M₁ and M₂ and the simulated data for signals S₁ and S₂ (80) as discussed herein above. The gradient of the AFD or PFD cost function and the velocity update direction are calculated (100) to obtain an updated velocity model (120). The updated velocity model may be input into the seismic wave propagation engine to obtain a new set of simulated data S₁ and S₂ to be used for cost function and data residual evaluation (140). The updated velocity model and the data fitting are judged (160). If the data fitting is satisfactory and the update velocity model is accepted, the beat tone FWI process finishes (180). Otherwise, using the calculated gradient of the cost function, the velocity model may be updated (170) and used as the input to operations 100, 120, 130, 140, and 160. These operations may repeat until the data fitting is satisfactory, and the reconstructed velocity model is satisfactory.

In some embodiments, additional operations may be included in the above described FWI operation. For example and without limitation, in some embodiments, the initial velocity model (10) may be obtained through well logs, velocity tomography procedures, or any other velocity analysis techniques. In some embodiments, in operation 40, besides initial velocity model and pre-processed seismic data, other available information (e.g., seismic migration image, geology information) may be used to help determine f₁ and f₂.

In some embodiments, in operation 70, the seismic wave propagation engine may be based on a time domain method or a frequency domain method. In some embodiments, it may be a finite-difference method, finite-element method, integral-equation method, or other numerical methods suitable for wave propagation simulations.

In some embodiments, in operations 80 and 100, extra regularization terms may be added to further stabilize the FWI processes.

In some embodiments, in operation 120, the updated velocity model may be further modified based on a priori information such as, for example and without limitation, water bottom profile or salt body geometry.

FIG. 9 illustrates a schematic diagram of a computer 900 according to an embodiment of the present disclosure. Computer 900 can be a desktop computer, laptop, tablet, or server. Computer 900 can represent at least one, but can be many computers, that can connect to a network to perform computational task, and store data information. Computer 900 includes at least one processor circuit, for example, having a processor 901 and a memory 902, both of which can be coupled to a first local interface 903. Memory 902 can comprise a seismic data processing application 904 and a data store 905. Seismic data processing application 904 can be a program application capable of generating a model of an underground formation from a seismic data 906 stored in data store 905. Seismic data processing application 904 can perform the methods described within this application. Such methods can include but are not limited to methods illustrated and described in FIG. 8. Seismic data 906 can be gathered seismic wave information from a receiver that provides a “time picture” of subsurface structure. First local interface 903 can comprise, for example, a data bus with an accompanying address/control bus or other bus structure as can be appreciated. In particular, stored in the memory 902 and executable by processor 901 are seismic data processing application 904, and potentially other applications. In one embodiment, computer 900 can be onsite and directly connected to receivers in the field. In another embodiment, receivers in the field can be connected to other computers that record seismic data 906. Seismic data 906 can then be transferred to computer 900 by network or other means so seismic data processing application 904 can perform the methods described in this application.

A number of software components can be stored in memory 902 and can be executable by processor 901. In this respect, the term “executable” means a program file that is in a form that can ultimately be run by processor 901. Examples of executable programs can be, for example, a compiled program that can be translated into machine code in a format that can be loaded into a random access portion of memory 902, and run by processor 901, source code that can be expressed in proper format such as object code that is capable of being loaded into a random access portion of memory 902 and executed by processor 901, or source code that can be interpreted by another executable program to generate instructions in a random-access portion of memory 902 to be executed by processor 901, etc. An executable program can be stored in any portion or component of memory 902 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory 902 is defined herein as including both volatile and nonvolatile memory and data storage components. Volatile components are those that do not retain data values upon loss of power. Nonvolatile components are those that retain data upon a loss of power. Thus, memory 902 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, processor 901 can represent multiple processor 901 and memory 902 can represent multiple memory 902 that operate in parallel processing circuits, respectively. In such a case, first local interface 903 can be an appropriate network, including network that facilitates communication between any two of the multiple processor 901, between any processor 901, and any of the memory 902, or between any two of the memory 902, etc. First local interface 903, can comprise additional systems designed to coordinate this communication, including, for example, performing load balancing. Processor 901 can be of electrical or of some other available construction.

Although seismic data processing application 904 and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 8 shows the functionality and operation of an implementation of portions of seismic data processing application 904. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as processor 901 in a computer system or other system. The machine code can be converted from the source code, etc. If embodied in hardware, each block can represent a circuit or a number of interconnected circuits to implement the specified logical function(s).

In the context of the present disclosure, a “computer-readable storage medium” can be any medium that can contain, store, or maintain the logic or application described herein for use by or in connection with the instruction execution system. The computer-readable storage medium can comprise any one of many physical media such as, for example, electronic, magnetic, optical, electromagnetic, infrared, or semiconductor media. More specific examples of a suitable computer-readable storage medium would include, but are not limited to, magnetic tapes, magnetic floppy diskettes, magnetic hard drives, memory cards, solid-state drives, USB flash drives, or optical discs. Also, the computer-readable storage medium can be a random-access memory (RAM) including, for example, static random access memory (SRAM) and dynamic random access memory (DRAM), or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method for generating a model of an underground formation from seismic data comprising:
receiving seismic data, the seismic data having previously been formed by emitting seismic waves into an underground formation by a source, and capturing the seismic data by one or more receivers in the time domain, the one or more receivers positioned to receive seismic waves from the underground formation, the seismic waves forming the seismic data;
converting the seismic data from the time domain to the frequency domain to form frequency domain seismic data;
extracting, from the frequency domain seismic data, first measured frequency domain data corresponding to a first signal at a first frequency;
extracting, from the frequency domain seismic data, second measured frequency domain data corresponding to a second signal at a second frequency, the second frequency different from the first frequency; and
generating, from a first velocity model, first simulated frequency domain data at the first frequency and second simulated frequency domain data at the second frequency.

2. The method of claim 1 further comprising the step calculating a gradient of a cost function utilizing the first and second measured frequency domain data and first and second simulated frequency domain data.

3. The method of claim 2 further comprising the step generating a second velocity model based at least in part on the calculated gradient, the second velocity model corresponding to at least one feature of the underground formation.

4. The method of claim 3, further comprising:
calculating a residual of the cost function utilizing the first and second measured frequency domain data and first and second simulated frequency domain data; and if the residual is over a predetermined threshold:
repeating the generating, calculating a gradient, updating, and calculating a residual operations until the residual is below the predetermined threshold.

5. The method of claim 3, further comprising:
calculating a residual of the cost function utilizing the first and second measured frequency domain data and first and second simulated frequency domain data; and if the residual is over a predetermined threshold:
repeating the generating, calculating a gradient, updating, and calculating a residual operations until the residual is minimized.

6. The method of claim 3, wherein the second model is generated utilizing an Amplitude-Frequency-Differentiation (AFD) operation, and the cost function is
C(mₙ)=½∥|S(ω₁)+S(ω₂)|²−|M(ω₁)+M(ω₂)|²∥²+λₙRₙ(mₙ)
where S is the simulated data, M is the measurement data, m is an unknown vector, a function of seismic velocity model v or compressibility model κ, to be inverted, λ is a regularization parameter, R is a regularization term, ω is an angular frequency, and n denotes an iteration index.

7. The method of claim 6, wherein the gradient of the cost function is calculated based on
$$\frac{\partial p}{\partial κ} = - {ρω}^{2} {\int }_{τ} p ( ω , κ ; x , {x}_{r} ) G ( ω , κ ; x , {x}_{s} ) dx$$
where p is the pressure, Q is the injected volume acting as the source, ρ is a mass density, κ is the compressibility of the medium, and G(w,κ;x,xₛ) is the solution to
∇²p+ω²ρκp=δ(x−xₛ).

8. The method of claim 3, wherein the second model is generated utilizing a Phase-Frequency-Differentiation (PFD) operation, and the cost function is given by:
C(mₙ)=½∥Φ[S(ω₂)/S(ω₁)]−Φ[M(ω₂)/M(ω₁)]∥²+λₙRₙ(mₙ)
where S is simulated data, M is the received seismic data, m is an unknown vector to be inverted, λ is a regularization parameter, R is a regularization term, w is an angular frequency, Φ is a phase extraction operator, and n is an iteration index.

9. The method of claim 6, wherein the gradient of the cost function is calculated based on
$$\frac{\partial p}{\partial κ} = - {ρω}^{2} {\int }_{τ} p ( ω , κ ; x , {x}_{r} ) G ( ω , κ ; x , {x}_{s} ) dx$$
where p is a pressure, Q is an injected volume acting as the source, ρ is a mass density, κ is the compressibility of a medium, and G(w,κ;x,xₛ) is the solution to
∇²p+ω²ρκp=δ(x−xₛ).

10. The method of claim 1 further comprising pre-processing the received seismic data.

11. The method of claim 1, further comprising:
determining the first and second frequencies, the first and second frequencies determined at least in part due to one or more of knowledge of the initial velocity model, the frequency range of the received seismic data, or the quality of the received seismic data.

12. The method of claim 1, wherein the first and second frequencies are between 4 and 100 Hz, between 5 and 30 Hz, or between 5 and 15 Hz.

13. The method of claim 1, wherein the first and second frequencies are separated by 5 Hz or less, 2 Hz or less, or 0.5 Hz or less.

14. The method of claim 1, wherein the first velocity model is determined through one or more of well logs, velocity tomography procedures, or any other velocity analysis techniques.

15. The method of claim 3, wherein the updating the first velocity model to a second velocity model operation is additionally based at least in part on water bottom profile or salt body geometry.

16. A system for generating a model of an underground formation from seismic data comprising
a memory, said memory comprising
a data store capable of storing seismic data; and
a seismic data processing application; and
a processor that, based on instructions of the seismic data processing application;
receives seismic data, the seismic data having previously been formed by emitting seismic waves into an underground formation by a source, and capturing the seismic data by one or more receivers in the time domain, the one or more receivers positioned to receive seismic waves from the underground formation, the seismic waves forming the seismic data;
converts the seismic data from the time domain to the frequency domain to form frequency domain seismic data;
extracts, from the frequency domain seismic data, first measured frequency domain data corresponding to a first signal at a first frequency;
extracts, from the frequency domain seismic data, second measured frequency domain data corresponding to a second signal at a second frequency, the second frequency different from the first frequency; and
generates, from a first velocity model, first simulated frequency domain data at the first frequency and second simulated frequency domain data at the second frequency.

17. The method of claim 16 wherein the processor further
calculates a gradient of a cost function utilizing the first and second measured frequency domain data and first and second simulated frequency domain data.

18. The method of claim 17 wherein the processor further
generates a second velocity model based at least in part on the calculated gradient, the second velocity model corresponding to at least one feature of the underground formation.

19. A non-transitory computer readable storage medium having a computer readable program code embodied therein, wherein the computer readable program code is adapted to be executed to implement the method of claim 1.
